(19) United States
(12) Patent Application Publication
(10) Pub. No.: US 2012/0218034 A1
(43) Pub. Date: Aug. 30, 2012

(54) VOLTAGE CALIBRATION METHOD AND APPARATUS

(76) Inventors: Sebastian Turullols, Los Altos, CA (US); Ali Vahidsafa, Palo Alto, CA (US); David Greenhill, (US)

(21) Appl. No.: 13/036,285

(22) Filed: Feb. 28, 2011

(51) Int. Cl. G05F 1/10

(52) U.S. Cl. 327/540

(57) ABSTRACT

A method and apparatus for power supply calibration to reduce voltage guardbands is disclosed. In one embodiment, an integrated circuit (IC) includes a voltage measurement unit configured to measure an operating voltage during a start-up procedure. The IC further includes a comparator configured to compare the measured operating voltage to a target voltage. The comparator is further configured to cause a change to a supply voltage (upon which the operating voltage is based) if the operating voltage is not within a target voltage range and to repeat the measurement of the operating voltage. If the operating voltage is within the target voltage range, the comparator is configured to inhibit further changes to the operating voltage.

### BACKGROUND

1. Field of the Invention

This invention relates to electronic circuits, and more particularly, to the calibration of voltages provided for powering to electronic circuits.

2. Description of the Related Art

Processors and other types of integrated circuits (ICs) used in computers and other electronic systems often receive power from a power supply that is externally located. The power supply may provide voltage to the IC at approximately a specified voltage with a specified current capacity. The voltage may be specified to a particular value which may be regulated by a voltage regulator. A voltage tolerance may cover a certain range of voltages on either side (i.e. higher or lower) of the specified voltage. The voltage tolerance is the imprecision with which a voltage value can be set. Power supplies and voltage regulator modules typically have a voltage tolerance. A power supply and/or voltage regulator may provide power at a voltage that is within a guard band based on the specified voltage and voltage tolerance. For example, a voltage regulator may provide power at a specified value of 1.0 volts with a tolerance of ±5%, which translates to a range of 0.95 volts to 1.05 volts.

A voltage guard band may be used to cover variations due to uncertainties in the environment associated with the supply voltage. Such uncertainties may include temperature, rapid changes in current demand from load fluctuation, impedances, and so forth. The guard band may factor in the tolerance of the supply voltage, as well as the environmental factors. Accordingly, ICs may also be specified to operate within the guard band specified for the power supply/voltage regulator. For example, to guarantee delivery of 1.0 volts, a guard band value of 0.1 volts may be chosen. The voltage of the power supply/voltage regulator may be set to 1.1 volts, with 0.055 volts budgeted for the voltage tolerance and 0.045 volts budgeted for other environmental factors.

Imprecision of power supplies and/or voltage regulators used in manufacturing testing and those used for system operation may have a cumulative affect on the guard band. For the example power supply above, to test a part at 1.0V, the tester power supply could be set to 1.1 volts. For system use, it could be assumed that the part has been tested at 1.15 volts. This may lead to adopting a system guard band of 0.2V, and setting the system power supply/voltage regulator to 1.2V. Although this is an extreme example, it does illustrate the impact of a voltage tolerance to the overall guard band, and to the overall loss of performance per Watt.

The ability of a particular IC to operate within the guard band specified may increase its flexibility with regard to system designs in which it may operate. However, operating within a large guard band may also result in a reduced performance per watt of power consumed. For example, if an IC operates at a higher voltage within a guard band than it actually required for a specified level of performance, the performance per watt of power consumed may be less than that which might otherwise be possible. Accordingly, in designing electronic systems, a trade-off may exist between the size of a guard band and the amount of performance achievable for a given unit of power consumption.

### SUMMARY OF THE DISCLOSURE

A method and apparatus for power supply calibration to reduce voltage guardbands is disclosed. In one embodiment, an integrated circuit (IC) includes a voltage measurement unit configured to measure an operating voltage during a start-up procedure. The IC further includes a comparator configured to compare the measured operating voltage to a target voltage. The comparator is further configured to cause a change to a supply voltage (upon which the operating voltage is based) if the operating voltage is not within a target voltage range and to repeat the measurement of the operating voltage. If the operating voltage is within the target voltage range, the comparator is configured to inhibit further changes to the operating voltage.

In one embodiment, a method for calibrating the operating voltage includes providing an operating voltage to an IC, and measuring the operating voltage. The method further includes reading a target voltage from a non-volatile memory and comparing the target voltage to a measure value of the operating voltage. If the operating voltage is not within a specified range based on the target voltage, the operating voltage may be adjusted and the measuring and comparing may be repeated. If the operating voltage is within the specified range, further adjustments to the operating voltage are discontinued.

A method for determining an operating voltage during a test is also disclosed. In one embodiment, the method includes a test system setting a supply voltage and a frequency of a clock signal provided to an IC under test. The method further includes conducting a test of the IC and determining if the test passed or not. If the test did not, the supply voltage may be adjusted and the test may be conducted again. If the test passes, the operating voltage received by the IC (which is based on a measured transistor voltage) may be determined and recorded in a non-volatile memory.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a computer system including a processor and a power supply;

FIG. 2 is a block diagram of one embodiment of an integrated circuit (IC) including a power calibration unit;

FIG. 3 is a block diagram of one embodiment of a power calibration unit;

FIG. 4 is a block diagram of one embodiment of an IC test system with an IC under test;

FIG. 5 is a flow diagram of one embodiment of a method for determining an IC operating voltage during a test of the IC; and

FIG. 6 is a flow diagram of one embodiment of a method for setting an operating voltage of an IC during a system startup.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION

### Computer System and Integrated Circuit Processor:

The disclosure herein is directed toward an apparatus which can obtain a precise measure of voltage received at the transistor level (or more generally, at the component level). This apparatus is then combined with additional hardware and software control infrastructures which, during manufacturing testing, record a number of environmental conditions, and then during system boot, adjust the system supply voltage until the chip internal conditions closely match the conditions present during manufacturing testing. The net effect is that the voltage tolerance may be substantially eliminated from the guard band value, enabling the system to operate at a lower voltage.

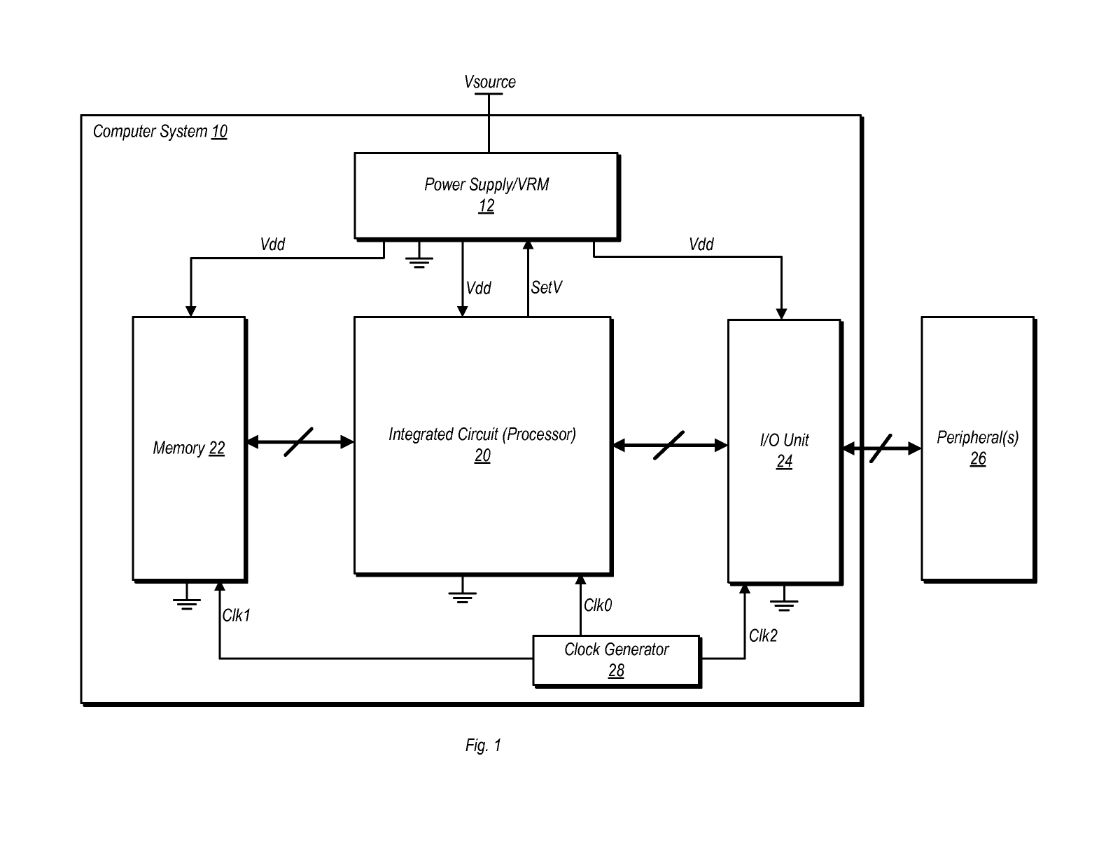

Turning now to FIG. 1, a block diagram of one embodiment of a computer system including a processor and a power supply is shown. In the embodiment shown, computer system 10 includes a power supply/voltage regulator module (VRM) 12, an integrated circuit (IC) 20 (which acts as the system processor in this embodiment), a memory 22, an input/output (I/O) unit 24, peripheral(s) 26, and a clock generator 28.

IC 20 may be one of a number of different types of processors. Such types include single core processors, heterogeneous multi-core processors, homogenous multi-core processors, system-on-a-chip (SOC) type processors, and so forth. It is further noted that IC 20 may also be an application specific IC (ASIC). In general, the power calibration methodology to be discussed below may be applied to virtually any type of IC, and thus the discussion of IC 20 as a processor herein is exemplary.

Memory 22 in the embodiment shown may include one or more types of memory. Possible memory types include dynamic random access memory (DRAM), static RAM (SRAM), flash memory, hard disk storage, and so forth. Memory 22 may include one or both of volatile and/or non-volatile memory types.

I/O unit 24 may function as an I/O bridge to provide an interface between IC 20 and various external devices. Peripheral(s) 26 may include one or more external devices such as printers, display units, keyboards, and so forth.

Clock generator 28 in the embodiment shown may provide clock signals Clk0, Clk1, and Clk2 to IC 20, memory 22, and I/O unit 24, respectively. The clock signals may be provided independently of another. Accordingly, their respective frequencies may also be different from one another. However, embodiments wherein the frequencies of these clock signals are the same are possible and contemplated. Various types of clock generation and modification circuitry may be implemented in clock generator 28. Such types of circuitry may include phase locked loops (PLLs), delay lock loops (DLLs), oscillators, or other circuitry for generating and/or modifying periodic signals.

Power supply/VRM 12 may provide supply voltages to IC 20, memory 22, and I/O unit 24 in the embodiment shown. Although not explicitly shown, clock generator 28 may also receive power via power supply/VRM 12. Peripheral(s) 26 may receive power from an external source, although in some embodiments, power supply/VRM 12 may also provide power thereto.

Computer system 10 may be any one of a wide variety of computer systems. It is noted that the method and apparatus of this disclosure may be utilized with any type of electronic system of which computer system 10 is but one example. Computer system 10 may be any type of computer system, with such types including desktop computer systems, laptops, servers, and various types of portable electronic devices (e.g., portable gaming devices, smart phones, etc.), among others. Thus, the external voltage source ('Vsource') from which power supply/VRM 12 in the embodiment shown is coupled to receive power may be an AC (alternating current) power source (e.g., a wall outlet), a battery, or any other suitable voltage source. Voltage provided to the various components of computer system 10 may be provided at a specified value (e.g., 1.1 volts) within a certain tolerance (e.g., ±5%).

The voltage at which IC 20 operates may be referred to as the operating voltage, or operational voltage, and is based on the supply voltage. In particular, supply voltage Vdd is provided by power supply/VRM to IC 20. However, this voltage may be altered somewhat in the path between power supply/VRM 12 and the actual circuitry within IC 20 that receives the voltage. This alteration of the voltage may be due to various factors, such as loading on the voltage planes of IC 20, impedances (e.g., capacitive and/or inductive) between power supply/VRM 12 and the circuits of IC 20, resistance in circuit board traces, among other causes. Accordingly, for the purposes of this disclosure, a distinction is made between the voltage that is provided by power supply/VRM 12 (the supply voltage') and the actual voltage received by the circuits of IC 20 (the operating voltage'). The circuits may include transistors and/or other components, and thus the operating voltage may be defined as that voltage which is actually received by the components of IC 20.

As previously noted, power supply/VRM 12 may include a guard band (or tolerance) of e.g., ±5%. This exemplary guard band may provide an allowance for variations in the supply voltage. However, the size of the guard band may also result in unrealized performance per watt of power consumed, as the operating voltage may be higher than necessary to achieve a certain level of performance. Accordingly, IC 20 may be configured to perform a voltage calibration routine in order to reduce the operating voltage to a minimum value for achieving a desired level of performance. In the embodiment shown, IC 20 is coupled to provide a voltage setting signal, SetV, to power supply/VRM 12. Responsive to the signal (which may be a digital signal of one or more bits in one embodiment), power supply/VRM 12 may adjust the supply voltage until the corresponding operating voltage received by the circuits of IC 20 reaches a desired level.

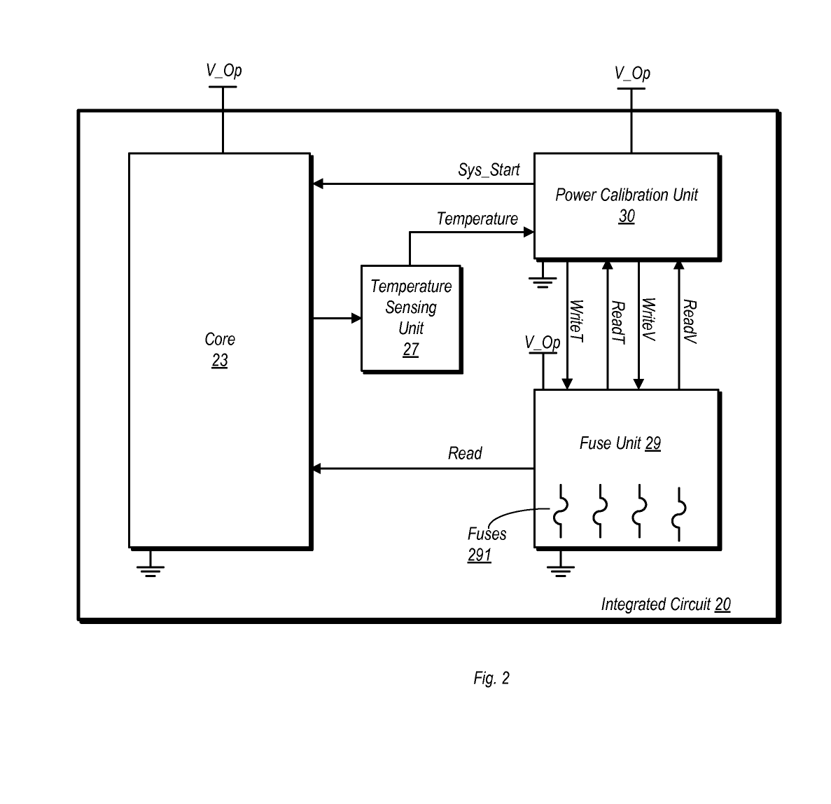

FIG. 2 is a block diagram of one embodiment of IC 20. In the embodiment shown, IC 20 includes at least one core 23 (which may provide the core functionality of IC 20), a power calibration unit 30, and a non-volatile memory in the form of fuse unit 29 (which includes a number of fuses 291). Each of core 23, power calibration unit 30, and fuse unit 29 are coupled to receive an operating voltage, V_Op, which is based on the supply voltage Vdd as explained above.

Power calibration unit 30 in the embodiment shown is configured to perform voltage calibration routines during both a manufacturing test of IC 20 and later during a system startup routine when IC 20 is implemented in an electronic (e.g., computer) system. During the manufacturing test, power calibration unit 30 may determine a lowest or near-lowest operating voltage value at which IC 20 may properly function. The operating voltage value determined by power calibration unit 30 may be recorded by blowing one or more fuses of fuse unit 29. Power calibration unit 30 may provide a number of digital signals on the multi-bit signal path WriteV in order to blow those fuses necessary to record the measured voltage value. When taken together, a number of fuses (both blown and un-blown) may form a digital code that represents the value of the voltage. The digital code may be a counter value programmed into the fuses that corresponds to a measured voltage value (the programming will be discussed in further detail below). Prior to a system startup routine subsequent to the test operation, power calibration unit 30 may read the voltage value (e.g., as a counter value that corresponds thereto) from fuse unit 29 via the multi-bit signal path ReadV. As will be explained below, the voltage value read from fuse unit 29 may be compared with a measured voltage value during a calibration routine.

In addition to recording the voltage in fuse unit 29, a temperature at which the test was conducted may be recorded by blowing additional fuses. In the embodiment shown, IC 20 includes a temperature sensing unit 27. Although not explicitly shown, IC 20 may include one or more temperature sensors configured to sense a temperature and coupled to report the same to temperature sensing unit 27. Any commonly used temperature sensor circuitry may be used to implement the temperature sensors. In some embodiments, multiple temperature sensors may be distributed throughout IC 20, and each may report a local temperature value to temperature sensing unit 27. In one embodiment, temperature-sensing unit 27 may average the values and report the average temperature to power calibration unit 30. In other embodiments, temperature-sensing unit 27 may report a high temperature, a low temperature, a median temperature, or another type of aggregated temperature value based on the information received from the temperature sensors. During the test operation, temperature sensing unit 27 may report a temperature value to power calibration unit 30, which may in turn record the value in fuse unit 29. During a subsequent startup routine, power calibration unit 30 may read the recorded temperature value as well as receiving a current temperature value from temperature sensing unit 27. Using these two temperature values, a compensation factor may be generated and applied to the voltage value read from fuse unit 29. The compensated voltage value may then be used as a basis for comparison with the measured voltage value during the calibration routine.

In addition to, or as an alternative to, temperature-sensing unit 27 may receive temperature readings from a source external to IC 20. Such temperature readings may be indicative of an ambient temperature surrounding IC 20 (e.g., within the chassis of a computer system). Such external temperatures may be used in determining a compensation factor for the recorded voltage values.

It is noted that while the voltage and temperature information is recorded in fuse unit 29 in the illustrated embodiment, other suitable types of non-volatile memories may be used for recording and storing the voltage and temperature values. Such types may include (but are not limited to) flash memories, electrically programmable read only memories (EPROMs).

As noted above, the calibration routine may be performed prior to a system startup routine. When power is initially applied to computer system 10, IC 20 may begin performing the calibration routine. Once the calibration routine has completed and the operating voltage has been set, power calibration unit 30 may assert a system start signal (Sys_Start'). Core 23 may then begin executing instructions to boot computer system 10.

### Power Calibration Unit:

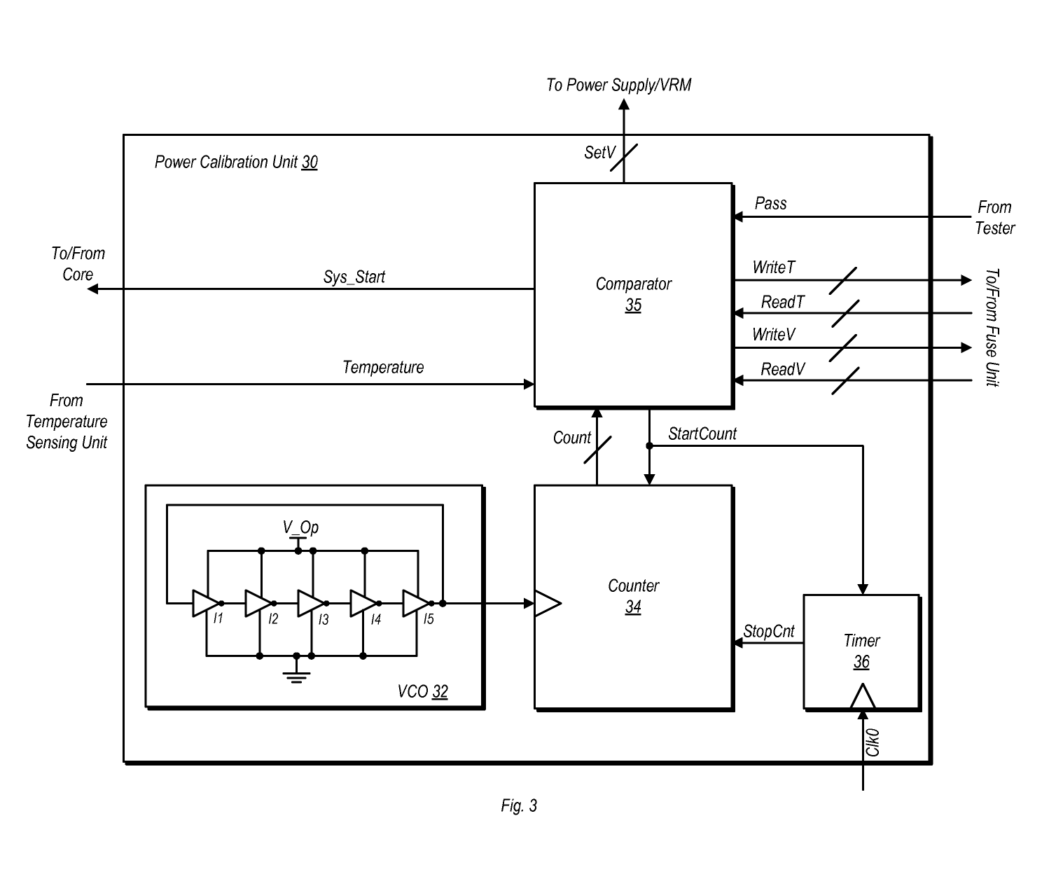

FIG. 3 is a block diagram of one embodiment of power calibration unit 30. In the embodiment shown, power calibration unit 30 includes a voltage controlled oscillator (VCO) 32, counter 34, timer 36, and comparator 35. These units may function to perform a calibration routine during a manufacturing test to determine and set a desired operating voltage. In addition, these units may be used to perform a calibration routine at power on time in an electronic system in order to set the operating voltage according to the value to which it was calibrated during the manufacturing test. In both calibration routines, power calibration unit 30 may provide a mechanism for performing a non-intrusive measurement of the actual voltage received by the transistors of IC 20. This voltage may differ some from the supply voltage due to impedances in the voltage and ground planes, the power supply connections, and so on. Accordingly, measuring the voltage at the transistor level using VCO 32 may provide a precise voltage measurement that is more representative of the actual performance of IC 20 than could be obtained through measuring the supply voltage. This in turn may allow the reduction of the voltage guard band and a corresponding increase in performance per watt of power consumed.

In the embodiment shown, VCO 32 is implemented as a ring oscillator that includes an odd number of inverters, I1-I5 in this case. Each of inverters I1-I5 is coupled to receive the operating voltage V_Op. The frequency of the output signal provided by VCO 32 may be proportional to V_Op. More particularly, the frequency of the output signal provided by VCO 32 is dependent on its gain, which may be expressed as frequency/voltage. For example, if the gain of VCO 32 is 4 GHz/V, then an output signal having a frequency of 4 GHz correspond to an operating voltage, V_Op, of 1 volt. Thus, VCO 32 may be used to perform a measurement of the operating voltage.

The output signal generated by VCO 32 may be provided to counter 34 as a clock signal. During a voltage measurement, counter 34 may be enabled to increment for a specified period. Timer 36 may be used to specify and enforce the period. In the embodiment shown, timer 36 is coupled to receive the clock signal, Clk0 that is provided to IC 20. Timer 36 may time the counting interval based on Clk0. The period may be initiated by the assertion of a start signal, ‘StartCount’, by comparator 35. The StartCount signal may reset counter 34 and timer 36. Counter 34 may begin incrementing from a value of 0, while timer may operate according to Clk0. When the period has elapsed, timer 36 may assert a stop signal, ‘StopCnt’, that causes counter 34 to discontinue counting. Timer 36 may also discontinue operation when the specified period has elapsed. The count value reached by counter 34 at the end of the specified time period is the number of cycles of the output signal provided by VCO 32. The number of cycles counted by counter 34 corresponds to the measured voltage of V_Op. This number is provided to comparator 35 in the embodiment shown. The measurement process performed by VCO 32, counter 34, and timer 36 may be performed during the calibration routines of the manufacturing test and at power on time when IC 20 is implemented in a system.

Comparator 35 in the embodiment shown is configured to provide a number of different functions. It is noted that comparator 35 may be implemented as either hardware or software, and thus its depiction as hardware in this particular example is not intended to be limiting. During the initial calibration performed during the manufacturing test, comparator 35 may receive the count from counter 34 for each measurement made. Comparator 35 is also coupled to receive an indication from a test system as to whether or not the test of IC 20 has passed (Pass). If the count value received by comparator 35 is updated, and the Pass signal has not been asserted, comparator 35 may assert one or more signals on the SetV signal path. These signals may be received by a test system, which may adjust the supply voltage provided therefrom accordingly. Comparator 35 may then assert the StartCount signal to initiate another measurement of the operating voltage. This process may be repeated for a number of iterations until IC 20 passes the manufacturing test and the Pass signal is asserted by the test system.

If the test of IC 20 passes, the test system may assert the Pass signal. When the Pass signal is asserted and the count has been updated, comparator 35 may write the count value (or a corresponding digital value) to fuse unit 29 in order to record the measured voltage value. The recorded value, which corresponds to the desired value of the operating voltage for the temperature at which the test was conducted (and which may be referred to as the target voltage), and may be used as the basis for future calibration routines. In addition to recording the measured voltage value, comparator 35 may blow an additional fuse (or perform some other recording function) to note that the initial calibration phase is complete. Furthermore, in recording the measured voltage value, comparator 35 may also blow one or more fuses to record a value corresponding to the temperature at which the test was conducted. The digital value representing the temperature may be conveyed to fuse unit 29 via the signal path WriteT, while the digital value representing the voltage may be conveyed to fuse unit 29 via the signal path WriteV.

After IC 20 has been implemented in a system, a pre-startup calibration routine may be performed when that system is powered on. During the pre-startup calibration routine, VCO 32, counter 34, and time 36 may perform a measurement of the operating voltage as previously described. Comparator 35 may initiate the measurement by asserting the StartCount signal. Upon completion of a measurement, the count value may be provided to comparator 35. The received count value may be compared to the value corresponding to the target voltage that was recorded during the manufacturing test. The comparison may be conducted for a number of the most significant bits of the two values. For example, if the count value and the recorded value are each 8-bit digital values, then comparator 35 may compare the most significant five bits of the two values. If these bits do not match, comparator 35 may, via the SetV signal path, command power supply/VRM 12 to change the supply voltage, which in turn will cause a change to the operating voltage. After the voltage change is complete, comparator 35 may assert the StartCount signal to initiate another iteration of measurement and comparison. If, on the other hand, the most significant 5 bits match, then comparator 35 may assert the system start signal (‘Sys_Start’), while discontinuing subsequent measurements and adjustments. Assertion of the Sys_Start signal may cause the system in which IC 20 is implemented (e.g., computer system 10) to being a system startup routine (e.g., in which a processor begins executing instructions to boot the system).

It is noted that the number of bits of the values, as well as the number of most significant bits for which a match is required, is exemplary. The number bits of the count value and the recorded value may be any suitable number. Similarly, the number of bits to be compared may also be any suitable number. The least significant bits that are not compared may represent a target voltage range, or guard band, for the operating voltage that may be significantly smaller than the guard band of the supply voltage. In turn, this may enable the system to optimize the amount of performance obtained per watt of power consumed.

As noted above, comparator 35 is coupled to receive one or more signals indicative of a temperature from temperature sensing unit 27. During the pre-startup calibration, comparator 35 in some embodiments may use this value in determining a compensation factor. The compensation factor may be used to adjust the digital value corresponding to the desired operating voltage stored in fuse unit 29 in order to adjust for temperature related voltage differences. In one embodiment, comparator 35 may include a look up table, which may be accessed prior to the comparing the value corresponding to the measured voltage to that corresponding to the target voltage. In the embodiment shown, the look up table may be implemented in fuse unit 29 by blowing selected fuses responsive to a passing manufacturing test. In another embodiment, a compensation factor may be stored in fuse unit 29 by blowing selected fuses responsive to a passing manufacturing test. The signals may be conveyed from comparator 35 to fuse unit 28 via the WriteT signal path. During the pre-startup calibration, the compensation factor may be accessed by comparator 35 via the signal path labeled ReadT.

The value corresponding to the target voltage may be adjusted according to the compensation factor in order to compensate for differences between the temperature at which the initial manufacturing test was conducted and a present temperature. As noted above, the temperature value received by comparator 35 may represent a temperature on IC 20, an ambient temperature, or some combination of both.

It is noted that the hardware arrangement discussed above is exemplary and is thus not intended to be limiting. Generally speaking, any suitable hardware implementation may be used to perform the procedures discussed above and to be further discussed below. The procedures include determining a target voltage during a manufacturing test and setting the operating voltage to the target voltage (or temperature-compensated value thereof) during a pre-startup calibration. The target voltage may be the lowest voltage at which IC 20 is capable of successfully passing the manufacturing test at a specified temperature. The pre-startup calibration includes measuring the operating voltage, comparing it to the target voltage (or compensated value thereof), and adjusting the operating voltage until it is within a target voltage range. Accordingly, any hardware capable of performing the procedures discussed herein may fall within the scope of this disclosure.

### Test System and Test Calibration Method:

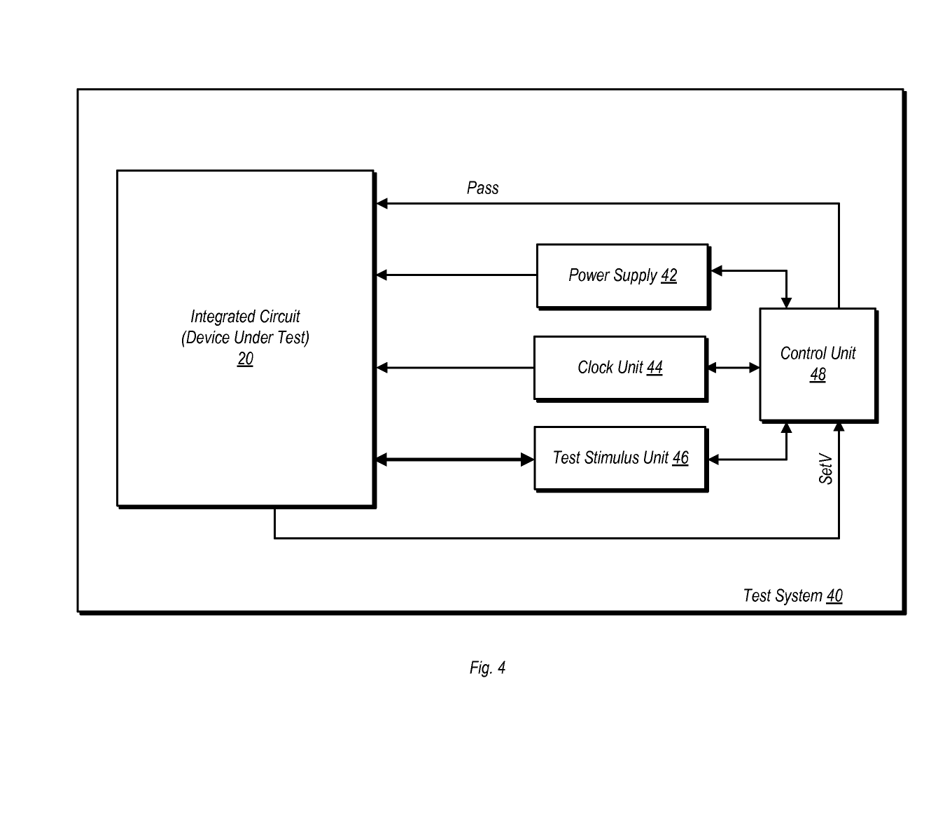

FIG. 4 is a block diagram of one embodiment of an IC test system with an IC under test. In the embodiment shown, test system 40 is configured to perform a test on IC 20 (the device under test). Test system 40 includes a power supply 42, a clock unit 44, a test stimulus unit 46, and a control unit 48. Each of these units may be coupled to IC 20 when it is the device under test.

Control unit 48 may coordinate the testing of IC 20. Accordingly, control unit 48 may issue commands to power supply 42 to set a supply voltage and to clock unit 44 to set a clock frequency. Power supply 42 may provide the supply voltage to IC 20. Similarly, clock unit 44 may provide a clock signal at a designated frequency to IC 20.

Control unit 48 may also issue commands to test stimulus unit 46, which may provide test stimulus data to IC 20 and may also receive test result data therefrom. Control unit 48 is also configured to receive one or more voltage adjustment signals via the SetV signal path from IC 20. Between iterations of a manufacturing test, control unit 48 may issue commands to power supply 42 to change the supply voltage responsive to receiving the voltage adjustment signals. Control unit 48 is also coupled to provide a pass signal to IC 20 when it has passed the manufacturing test.

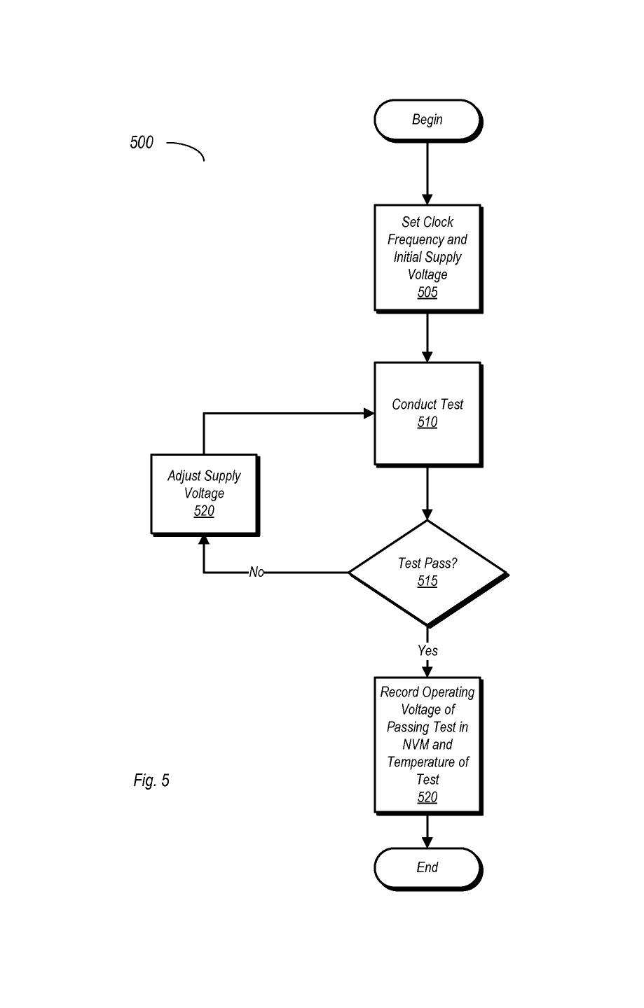

Turning now to FIG. 5, a flow diagram of one embodiment of a method for determining an IC operating voltage during a test of the IC is illustrated. Method 500 may be compatible with the various hardware and test system embodiments discussed above, as well as embodiments of both that have not been explicitly discussed herein.

Method 500 begins with a test system setting a clock frequency and an initial supply voltage at which a manufacturing test of an IC is to be conducted (block 505). The initial supply voltage may be a lowest voltage at which the test is to be conducted. The method may also include either setting a temperature value at this point or recording the temperature value for future reference.

After setting the clock frequency and the supply voltage, the test system may conduct a test of the IC (block 510). The test may include providing test stimulus data to the IC and, responsive thereto, receiving test result data from the IC. The test system may analyze the data to determine if the test passed or failed. The test may also include measuring an operating voltage, which is the voltage that is actually received by the circuits of IC 20. As previously noted, this voltage may be different from the supply voltage due to various factors such as loading, impedances in the conductive path between the power supply and the power planes of the IC, and so on.

If the test did not pass (block 515, no), then the supply voltage may be adjusted (block 520). In one embodiment, the supply voltage may be increased. After the supply voltage has been adjusted, the test may be conducted again (block 510) and a pass/fail result may be determined (block 515). This loop may be repeated each time the test fails, with the supply voltage progressively increased each iteration.

If the test passed (block 515, yes), the operating voltage may be recorded in a non-volatile memory (block 520). The operating voltage may be represented by a digital value that is determined during the measurements performed during the test phase. The digital value may include a number of bits, all of which (from most to least significant) are recorded. Furthermore, since the supply voltage (and thus the operating voltage) were at a low point for the first iteration and increased in any successive iteration that may have occurred, the recorded value may represent the lowest operating voltage at which IC passed the test. This voltage may thus become a target voltage for use during a pre-startup calibration procedure to be discussed below. Furthermore, a target voltage range may be defined based on the recorded target voltage, and may be represented by one or more of the least significant bits of the recorded operational voltage value.

It is noted that the procedure described above may be conducted for a number of different clock frequencies, and the lowest operating voltages for a passing test may be recorded for each one. Accordingly, embodiments of an IC are possible and contemplated in which a number of different target voltages are determined and recorded. Similarly, for a given clock frequency, a number of tests may be performed at various temperatures. The data obtained from such tests may be used to determine temperature compensation factors that may be subsequently be used to compensate a target voltage for a different operating environment. It is noted however the compensation factors may be derived from other methods as well, such as characterization tests that are not explicitly discussed as being part of the methodology of FIG. 5.

### Pre-Startup Calibration Method:

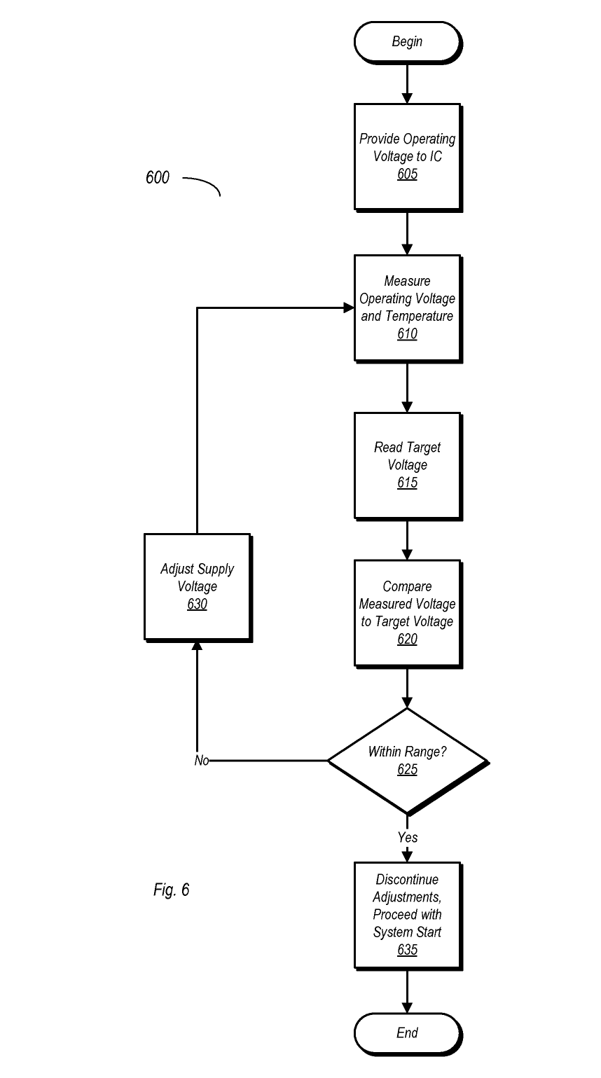

FIG. 6 is a flow diagram of one embodiment of a method for setting an operating voltage of an IC during a system startup. Method 600 is one embodiment of a voltage calibration method that may set an operating voltage to a value that is based on a target voltage determined during a manufacturing test per an embodiment of method 500 discussed above.

Method 600 begins with the application of power to an electronic system and thus the providing of an operating voltage to the circuits of an IC (block 605). A frequency of a clock signal may also be set in conjunction with the provision of power. After power has been applied, the operating voltage is measured (block 610). In addition to measuring the operating voltage, a target voltage is read from a non-volatile memory (block 615) in which it was recorded during the manufacturing test calibration discussed above. The measured operating voltage may be compared to the target voltage (block 620).

The comparison operation may determine whether the operating voltage is within a target voltage range (block 625). In one embodiment, both the operating voltage and the target voltage are expressed as digital values having multiple bits. A certain number of the most significant bits are compared to each other, while no comparison is made of the remaining least significant bits. Thus, the actual comparison operation may determine if the operating voltage is within a target voltage range that may vary by an amount that may be expressed in the least significant bits of the target voltage value. For example, if the number of least significant bits that are not compared is three, then the target voltage range may vary by an amount that may be expressed from a binary value of 000 to a binary value of 111. Thus, if one bit is equivalent to a voltage of 0.0025 V, then the target voltage range may be 0.02 V.

If the comparison determines that the operating voltage is not within the target voltage range (block 625, no), then the supply voltage (upon which the operating voltage is based) may be adjusted (block 630). In contrast to the methodology described with reference to FIG. 5, method 600 begins with a high voltage at which it is known that IC 20 will properly function and then reduces the voltage on subsequent iterations. Thus, the supply voltage is reduced in block 630 in this particular embodiment. After adjusting the supply voltage, another operating voltage measurement is performed (block 610), the target voltage is re-read (block 615), and the comparison of the measured voltage to the target voltage is performed (block 620). This may be performed for a number of iterations in some cases.

If the operating voltage is determined to be within the target voltage range (block 625, yes), then further adjustments to the supply voltage (and thus the operating voltage) are discontinued (block 635). Furthermore, the system in which IC 20 is implemented (e.g., a computer system wherein IC 20 is a processor) may then begin a system start routine (e.g., wherein the processor begins executing instructions as part of a boot routine).

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. An integrated circuit (IC) comprising:
a voltage measurement unit, wherein the voltage measurement unit is configured to, during a start-up procedure, measure a value of an operating voltage received by the IC; and
a comparator configured to compare the value of the operating voltage to a target voltage, wherein the comparator is further configured to:
cause a power supply to change a supply voltage upon which the operating voltage is based responsive to determining that the value of the operating voltage is not within a target voltage range based on the target voltage;
cause the voltage measurement unit to repeat measuring the value of the operating voltage subsequent to the power supply changing the operating voltage; and
discontinue causing further changes to the operating voltage responsive to determining that the operating voltage is within the target voltage range.

2. The IC as recited in claim 1, wherein the comparator is further configured to, during a manufacturing test, write a target voltage value into a non-volatile memory responsive to the IC passing the manufacturing test at a specified clock frequency, wherein the target voltage value is equal to the value of the operating voltage measured by the voltage measurement unit during the manufacturing test.

3. The IC as recited in claim 2, wherein the comparator is configured to determine the target voltage range based on the target voltage value, wherein the target voltage value is represented by a first plurality of bits, and wherein the value of the operating voltage provided by the voltage measurement unit is represented by a second plurality of bits.

4. The IC as recited in claim 3, wherein the comparator is configured to determine that the operating voltage is within the target voltage range responsive to a subset of most significant bits of the first plurality of bits matching a subset of most significant bits of the second plurality of bits.

5. The IC as recited in claim 2, wherein the non-volatile memory includes a plurality of fuses, wherein the comparator is configured to write the target voltage value by blowing one or more of the plurality of fuses, and wherein the comparator is configured to read the target voltage value by reading the plurality of fuses.

6. The IC as recited in claim 5, wherein the comparator is configured to write the target voltage value as a lowest operating voltage value measured by the voltage measurement unit at which the IC passed the manufacturing test.

7. The IC as recited in claim 2, wherein the comparator is configured to adjust the target voltage based on a difference between a temperature of the IC at which the manufacturing test was conducted and a current temperature of the IC.

8. The IC as recited in claim 1, wherein the voltage measurement circuit includes a voltage controlled oscillator (VCO) and a counter, wherein the VCO is configured to generate an output signal having a frequency based on the operating voltage, and wherein the counter is configured to increment based on the output signal.

9. The IC as recited in claim 8, wherein the voltage measurement unit further includes a timer coupled to receive a system clock signal, wherein the timer is configured to halt the counter after a specified time period has elapsed, and wherein the voltage measurement unit is configured to determine the operating voltage based on a count value reached by the counter at the end of the specified time period.

10. The IC as recited in claim 8, wherein the VCO is a ring oscillator.

11. A method comprising:
providing an operating voltage to an integrated circuit (IC);
measuring the operating voltage;
reading a target voltage from a non-volatile memory;
comparing the target voltage to a measured value of the operating voltage;
if said comparing determines that that the operating voltage is not within a specified range based on the target voltage, adjusting the operating voltage and repeating said measuring, said reading, and said comparing; and
if said comparing determines that the operating voltage is within the specified range, discontinuing further adjustments to the operating voltage.

12. The method as recited in claim 11, wherein said adjusting comprises reducing the operating voltage, and wherein reducing the operating voltage comprises reducing a supply voltage provided to the IC from an external source.

13. The method as recited in claim 11, wherein said measuring comprises an output signal of a voltage controlled oscillator (VCO) toggling a counter for a specified time period, wherein a count value at the end of the specified time period corresponds to a measured value of the operating voltage.

14. The method as recited in claim 13, wherein the count value at the end of the specified time period comprises a first plurality of bits, wherein the target voltage is represented by a second plurality of bits, wherein each of the first and second plurality of bits includes an equal number of bits, wherein said comparing comprises comparing a most significant subset of the first plurality of bits to a most significant subset of the second plurality of bits, and wherein determining that the operating voltage is within the specified voltage range comprises determining that the most significant subset of the first plurality of bits matches the most significant subset of the second plurality of bits.

15. The method as recited in claim 11, further comprising adjusting the target voltage value prior to said comparing, wherein said adjusting the target voltage value is based on a difference between a present temperature of the IC and a temperature of the IC when the target voltage value was written into the non-volatile memory.

16. A method comprising:
a test system setting a frequency of a clock signal provided to an integrated circuit (IC) to a specified clock frequency;
the test system setting a supply voltage provided to the IC;
conducting a test of the IC at the specified clock frequency and the supply voltage, wherein said testing includes measuring a component voltage;
determining if the test passed;
wherein, if the test did not pass:
adjusting the supply voltage to a new value; and
repeating said conducting the test and said determining if the test passed; and
wherein, if the test passed:
determining an operational voltage of the IC, wherein the operational voltage value is based on the component voltage measured when the test passed; and
recording the operational voltage value in a non-volatile memory.

17. The method as recited in claim 16, wherein said adjusting comprises increasing the supply voltage, and wherein said recording the operational voltage comprises recording a lowest value of the operational voltage at which the test passed.

18. The method as recited in claim 16, wherein said determining the operational voltage comprises:
a voltage controlled oscillator (VCO) generating an output signal, wherein a frequency of the output signal is based on the operational voltage;
providing the output signal to a counter and toggling the counter at the frequency of the output signal; and
halting the counter after a specified time has elapsed, wherein a count value provided by the counter at the end of the specified time corresponds to a measured value of the operational voltage.

19. The method as recited in claim 16, wherein the non-volatile memory includes a plurality of fuses, said recording the operational voltage comprises blowing each of at least a subset of the plurality of fuses.

20. The method as recited in claim 16, further comprising recording a temperature of the IC at which the test passed.
